(19) United States
(12) Patent Application Publication
(10) Pub. No.: US 2001/0008528 A1
(43) Pub. Date: Jul. 19, 2001

(54) Communication path control method and repeating apparatus

(75) Inventor: Ayako Suzuki, Kawasaki (JP)

Correspondence Address: HELFGOTT & KARAS, P.C., EMPIRE STATE BUILDING, 60th FLOOR, NEW YORK, NY, 10118, US

(73) Assignee: FUJITSU LIMITED

(21) Appl. No.: 09/731,692

(22) Filed: Dec. 6, 2000

(30) Foreign Application Priority Data
Jan. 18, 2000 (JP) 2000-009374

(51) Int. Cl. G06F 15/16; H04J 3/00

(52) U.S. Cl. 370/390; 370/401; 370/475; 370/476; 370/522; 709/249; 370/392

(57) ABSTRACT

In a repeating apparatus of a layer 2 LAN, when a received frame is a destination-unknown frame, a frame for path detection having a shortest data length is generated using a destination address of the above-mentioned received frame and an address of the own apparatus and it is broadcasted; and when a responding frame returned from a repeating apparatus having found the destination for the above-mentioned frame for path detection is received, the above-mentioned received frame is transmitted for a transmission source of the above-mentioned responding frame.

### BACKGROUND OF THE INVENTION

1. Field of the Invention

The present invention relates to a communication path control method and a repeating apparatus, and, in particular, a method of controlling communication paths in a layer 2 LAN and a layer 2 LAN repeating apparatus.

2. Description of the Related Art

Recently, a layer 2 LAN (Local Area Network) has been a main current of communication networks. A layer 2 LAN is configured by connecting a plurality of layer 2 LAN repeating apparatuses.

FIG. 1 shows a block diagram of one example of a layer 2 LAN repeating apparatus in the related art.

The repeating apparatus shown in the figure includes a plurality of transmission/reception interface ports. An Ethernet data frame received through any of the transmission/reception interface ports 10 is provided to a repeating control part 12. The repeating control part 12 provides a destination address of the received frame to an address searching part 14, and requests the part 14 to detect a port corresponding to the destination address. The address searching part 14 searches an address table 16 by the destination address and detects the corresponding port.

When the corresponding port is detected, the repeating control part 12 sends out the above-mentioned received frame through the detected corresponding port.

However, when the corresponding port is not detected, the repeating control part 12 broadcasts that received frame through all the ports other than the reception port.

When each of all layer 2 repeating apparatuses having received the above-mentioned broadcasted frame has a destination address in its address table, and recognizes the destination of the received data frame, the broadcasting stops.

In this case, the increasing rate of transfer frames due to copying is expressed by ‘O’ (big o) of the following equation (1), the increasing rate of the number of frames is limited to the number of adjacent repeating apparatuses, and is not particularly problematic.

O(x−1)÷O(x) (1)

where ‘x’ denotes the number of repeating apparatuses adjacent to the layer 2 LAN repeating apparatus concerned, and ÷ means ‘is nearly equal to’.

Description will now be made with regard to ‘O’ (big o).

There are functions ‘f’ and ‘g’, and a constant ‘c’ is assumed to be such that c>0.

f(x)=O(g(x)) means that |f(x)|≦cg(x)

when x≧x0 (x0 is a constant).

For example, for the functions ‘f’ and ‘g’ such that f(x)=x−1 and g(x)=x,

|x−1|x, for all x≧1

when it is assumed that c=1 and x0=1.

Accordingly, it can be said that x−1=O(x).

That is, g(x) expresses the upper limit of f(x), and there is no possibility that f(x) exceeds g(x) however large x is.

However, when a destination of a received data frame is not recognized in each of all the layer 2 LAN repeating apparatuses having received the broadcasted frame, each frame is copied each time passing through the repeating apparatus by the number of adjacent repeating apparatuses.

Accordingly, the total of increasing rates of the transfer frames increases exponentially, and becomes a very large value expressed by the following equation (2):

O(x−1)^{A}÷O(X)^{A} (2)

where ‘A’ denotes the number of repeating stages passed through.

When the broadcasted frame is a data frame, because the frame length thereof is relatively long (the maximum length of Ethernet frame is 1518 bytes), a load to the transmission path is heavy, and may results in degradation of signal transmission performance.

Further, in the related art, STP (Spanning Tree Protocol) is used for avoiding looping of a path configured in a network.

However, in STP, regular communications such as a BPDU (Bridge Protocol Data Unit) packet for setting connection/disconnection between repeating apparatuses and a Hello packet for assuring connection between repeating apparatuses become a load to a signal transmission path, and results in degradation of communication performance.

Further, when change of topology such as addition/deletion of terminals and repeating apparatuses occurs, STP is to be reconfigured. However, this takes a time of several minutes, and communication stops during it.

Thus, in a layer 2 LAN repeating apparatus in the related art, broadcasting transfer of a received frame is performed when a destination of the received frame cannot be recognized.

However, when a destination-unknown received frame has a long data frame having a long average frame length, a load to a transmission path increases and results in obstruction to efficient communication.

Further, stop of communication at a time of regular communication or change of topology due to employment of STP results in degradation of communication performance.

### SUMMARY OF THE INVENTION

The present invention is made in consideration of the above-mentioned problems, and, an object of the present invention is to provide a communication path control method and a repeating apparatus by which a load to a transmission path can be reduced and efficient communication is made possible, it is possible to avoid an infinite loop without using STP, and no stop of communication occurs at a time of change of topology.

According to the present invention, in a repeating apparatus of a layer 2 LAN,

when a received frame is a destination-unknown frame, a frame for path detection having a shortest data length is generated using a destination address of the above-mentioned received frame and an address of the own apparatus and it is broadcasted; and

when a responding frame returned from a repeating apparatus having found the destination for the above-mentioned frame for path detection is received, the above-mentioned received frame is transmitted for a transmission source of the above-mentioned responding frame.

Thereby, it is possible to reduce a load of a transmission path and to perform efficient communication as a result of a frame broadcasted having a short data length.

According to another aspect of the present invention, in a repeating apparatus of a layer 2 LAN,

when a received frame is a broadcast frame or a destination-unknown frame, the received frame or a derivative frame thereof is stored; and

when receiving the frame the same as the above-mentioned received frame or derivative frame within a predetermined time from the storage of the above-mentioned received frame or derivative frame, the received same frame is discarded.

Thereby, it is possible to avoid generation of an infinite loop. Further, because STP is not used, there is no possibility that stop of communication at a time of increase of load of transmission path or change of topology.

According to another aspect of the present invention, in a repeating apparatus of a layer 2 LAN,

when a received frame is a broadcast frame or a destination-unknown frame, the received frame or a derivative frame thereof is stored;

when the received frame is a destination-unknown frame, a frame for path detection having a shortest data length is generated using a destination address of the above-mentioned received frame and an address of the own apparatus and is broadcasted;

when the frame the same as the above-mentioned received frame or derivative frame is received within a predetermined time from the storage of the above-mentioned received frame or derivative frame, the received same frame is discarded;

when a responding frame returned from a repeating apparatus having found the destination for the above-mentioned frame for path detection is received, the above-mentioned received frame is transmitted for a transmission source of the above-mentioned responding frame.

Thus, when the received frame is a destination-unknown frame, a frame for path detection having a shortest data length is generated using a destination address of the above-mentioned received frame and an address of the own apparatus and is broadcasted, and, when a responding frame is received, the above-mentioned received frame is transmitted for a transmission source of the above-mentioned responding frame. Thereby, it is possible to reduce a load of a transmission path and to perform efficient communication as a result of a frame broadcasted having a short data length.

Further, when a received frame is a broadcast frame or a destination-unknown frame, the received frame or a derivative frame thereof is stored, and, when the frame the same as the above-mentioned received frame or derivative frame is received within a predetermined time from the storage of the above-mentioned received frame, the received same frame is discarded. Thereby, it is possible to avoid occurrence of an infinite loop. Further, because STP is not used, there is no possibility that stop of communication at a time of increase of load of transmission path or change of topology.

Further, it is preferable that, when a received frame is the above-mentioned frame for path detection and is of destination unknown in the own apparatus, the received frame for path detection is held, and also, is broadcasted.

Thereby, it is possible to search all the transmission paths using the frame for path detection.

It is also preferable that a timer part is provided for measuring a time for which the received frame or derivative frame is stored, and, for, when the predetermined time has elapsed, discarding the received frame or derivative frame.

Thereby, it is possible to prevent the received frame from being stored for a long time and to reduce a load of the apparatus.

Other objects and further features of the present invention will become more apparent from the following detailed description when read in conjunction with the accompanying drawings.

### BRIEF DESCRIPTION OF THE DRAWINGS

FIG. 1 shows a block diagram of one example of a layer 2 LAN repeating apparatus in the related art;

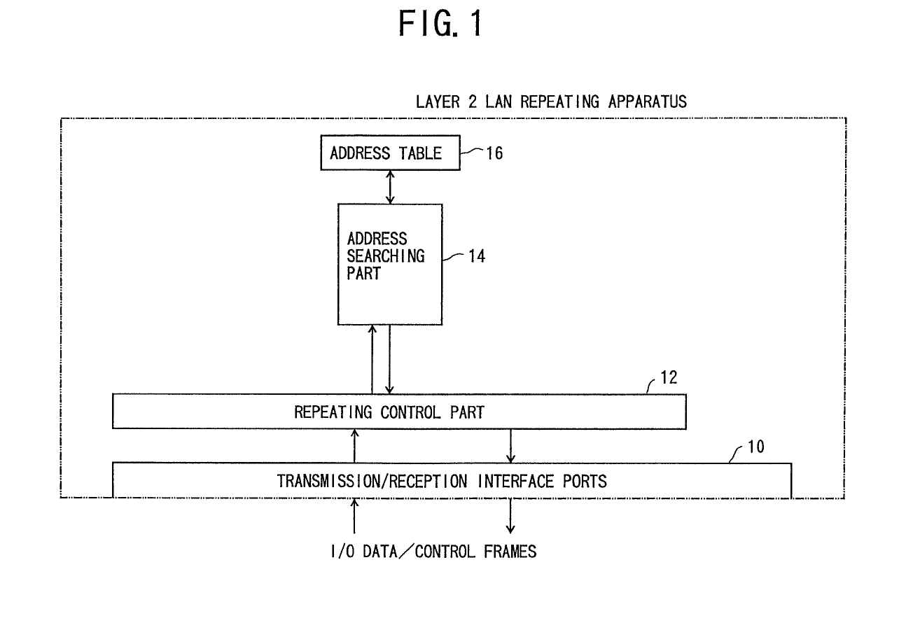

FIG. 2 shows a block diagram of a layer 2 LAN repeating apparatus in one embodiment of the present invention;

FIGS. 3A, 3B and 3C show data configurations in respective frame types;

FIGS. 4, 5 and 6 show a flow chart of one embodiment of processing performed by the layer 2 LAN repeating apparatus shown in FIG. 2 when a frame is received by the apparatus according to the present invention;

FIG. 7 shows a flow chart of one embodiment of a timer interrupt routine performed by the layer 2 LAN repeating apparatus shown in FIG. 2 according to the present invention;

FIG. 8 shows a block diagram of a network in a first embodiment to which the method in the embodiment according to the present invention is applied;

FIG. 9 shows a block diagram of a network in a second embodiment to which the method in the embodiment according to the present invention is applied;

FIGS. 10A, 10B and 10C show examples of the contents of respective address tables of repeating apparatuses shown in FIG. 9;

FIG. 11 shows a block diagram of a network in a third embodiment to which the method in the embodiment according to the present invention is applied;

FIG. 12 shows a configuration of a network to which the method in the embodiment of the present invention is applied for illustrating an effect of the method of the present invention; and

FIG. 13 shows a traffic amount in the network shown in FIG. 12 at a time of broadcasting.

### DETAILED DESCRIPTION OF THE PREFERRED EMBODIMENT

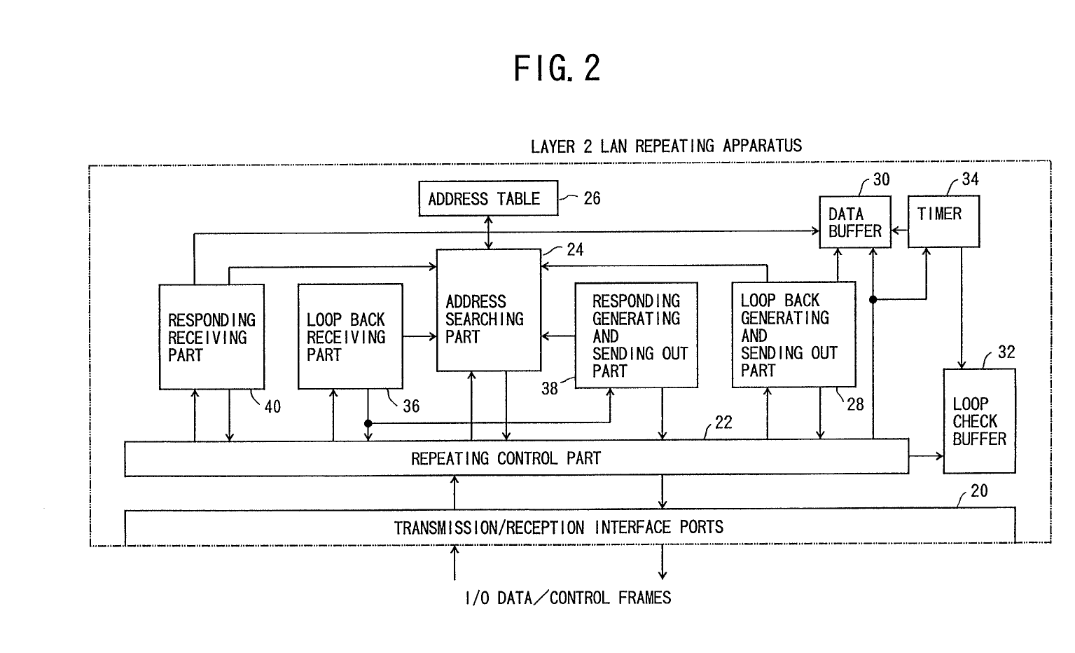

FIG. 2 shows a block diagram of one embodiment of a layer 2 LAN repeating apparatus according to the present invention.

The layer 2 LAN repeating apparatus shown in FIG. 2 includes a plurality of transmission/reception interface ports 20, and, a frame received through any port (referred to as a reception port, hereinafter) of the transmission/reception interface ports 20 is provided to a repeating control part 22. The repeating control part 22 determines a frame type of the received frame.

There are a plurality of frame types for frames received.

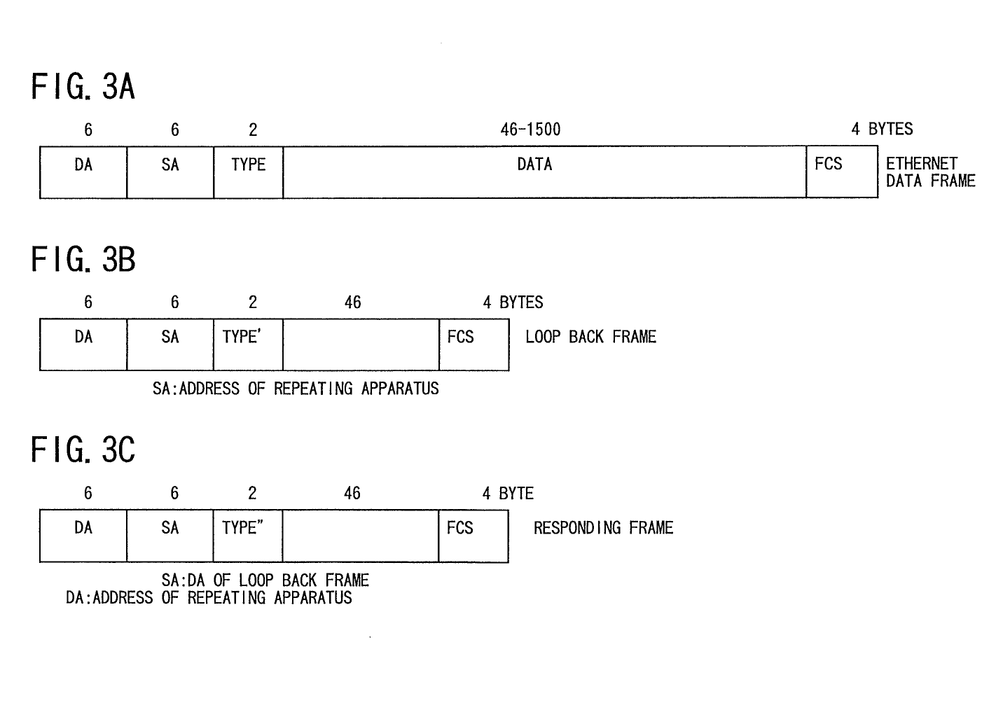

A first frame type is an Ethernet data frame, and, as shown in FIG. 3A, an Ethernet data frame includes six bytes of a destination address DA, six bytes of transmission source address SA, two bytes of data type TYPE indicating the frame type, 46 through 1500 bytes of variable length data, and a frame check sequence FCS for error detection.

Ethernet data frames are variable in length.

A second frame type is a loop back frame, and, as shown in FIG. 3B, a loop back frame includes six bytes of destination address DA (=the transmission source address SA of an Ethernet data frame), six bytes of transmission source address SA (=the address of an repeating apparatus sending out the loop back frame), two bytes of data type TYPE indicating the data type, 46 bytes of blank data, and frame check sequence FCS for error detection.

Loop back frames are of 64-byte fixed length.

A third frame type is a responding frame, and, as shown in FIG. 3C, a responding frame includes six bytes of destination address DA (=the transmission source address SA of a loop back frame), six bytes of transmission source address SA (=the destination address DA of the loop back frame), two bytes of data type TYPE indicating the data type, 46 bytes of blank data and a frame check sequence FCS.

Responding frames are of 64-byte fixed length.

The reason why the blank data is provided in loop back frame and responding frame is that the minimum frame length in network is prescribed as 64 bytes.

Whether a data frame is a uni-cast frame having a single destination or a broadcast frame having a plurality of destinations is determined from the destination address DA of the data frame.

The destination address DA of a uni-cast frame has a particular address value (all the bits of which are not ‘1’) while the destination address DA of a broadcast frame is such that all the bits thereof are ‘1’.

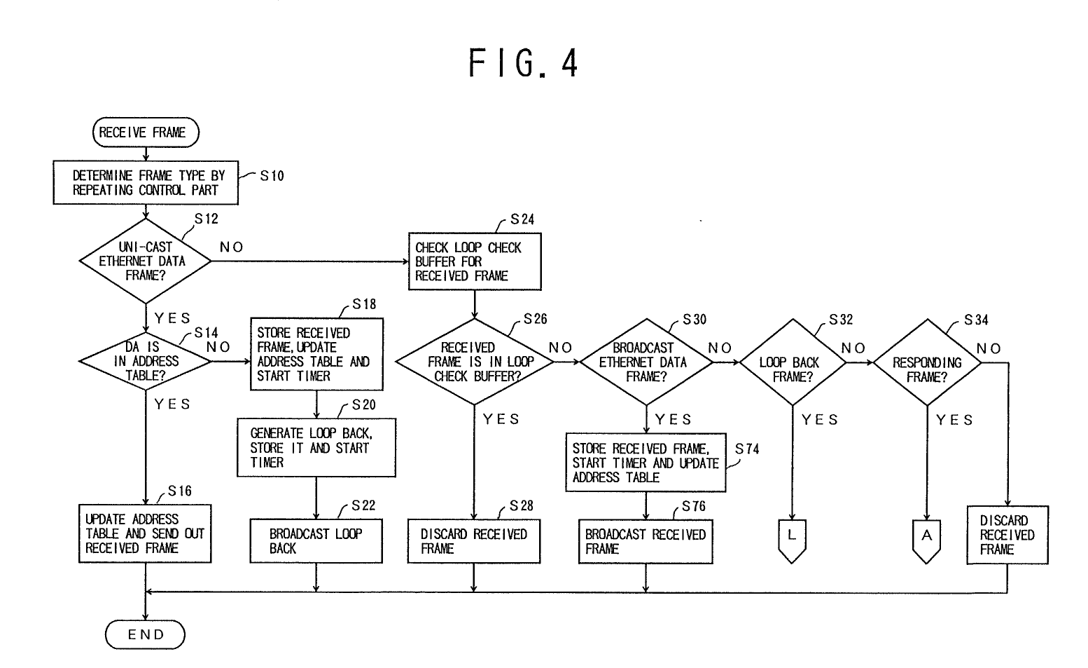

FIGS. 4 through 7 show flow charts of processing performed by the layer 2 LAN repeating apparatus in the embodiment of the present invention shown in FIG. 2 when a frame is received thereby.

With reference to FIGS. 2 through 4, in steps S10 and S12, the repeating control part 22 determines the frame type of a received frame.

When the received frame is a uni-cast Ethernet data frame, the destination address DA of the received frame is provided to an address searching part 24 in a step S14, and detection of a port corresponding to that destination address DA is requested of the address searching part 24. The address searching part 24 searches an address table 26 by the destination address DA so as to detect the corresponding port.

When the corresponding port is then detected, the repeating control part 22 uses the address searching part 24, writes the transmission source address SA of the received frame to the address table 26 so as to cause the transmission source address SA to correspond to the reception port and thus updates the address table 26, and sends out the received frame through the detected corresponding port, in a step S16.

When no corresponding port is then detected, the repeating control part 22 having received the report indicating this result from the address searching part 24 temporarily stores the received frame in a data buffer 30, uses the address searching part 24, writes the transmission source address SA of the received frame to the address table 26 so as to cause the transmission source address SA to correspond to the reception port and thus updates the address table 26, in a step S18.

Simultaneously, the repeating control part 22 initializes a partial timer of a timer 34 and causes it to start, the partial timer corresponding to the received frame concerned.

Then, in a step S20, the repeating control part 22 instructs a loop back generating and sending out part 28 to generate a loop back frame shown in FIG. 3B.

The loop back generating and sending out part 28 generates a loop back frame by incorporating the destination address DA of the received frame and an address particular to the own repeating apparatus into the destination address DA and transmission source address SA of the loop back frame shown in FIG. 3B, respectively.

The repeating control part 22 stores the generated loop back frame in a loop check buffer 32, then, sends out and broadcasts the loop back frame through all the port of the transmission/reception interface ports 20 other than the reception port, in a step S22.

Simultaneously, in order to limit a time for waiting a responding frame, the repeating control part 22 initializes a partial timer of a timer 34 and causes it to start, the partial timer corresponding to the loop back frame concerned.

When the frame type of the received frame is not a uni-cast Ethernet data frame, the repeating control part 22 determines whether the frame identical to the received frame is stored in the loop check buffer 32, in steps S24 and S26.

When the identical frame is stored in the loop check buffer 32, it is determined that an infinite loop is generated, and the received frame is discarded by the repeating control part 22, in a step S28.

However, when no identical frame is stored in the loop check buffer 32, it is determined in steps S30, S32 and S34 whether the received frame is a broadcast Ethernet data frame, a loop back frame or a responding frame, and, one of the following processes is performed according to the thus-determined frame type of the received frame, by the repeating control part 22.

When the received frame is a loop back frame, a step S40 of FIG. 5 is proceeded to, and, by control of the repeating control part 22, the received loop back frame is provided to a loop back receiving part 36.

The loop back receiving part 36 compares the destination address DA of the received loop back frame with the address particular to the own repeating apparatus, and, also, uses the address searching part 24 and searches the address table 26 for a port of the transmission/reception interface ports 20 corresponding to the destination of the received loop back frame, in a step S42.

Then, when the destination of the received loop back frame is the own repeating apparatus or the destination of the received loop back frame exists in the address table 26, the loop back receiving part 36 instructs a responding frame generating and sending out part 38 to generate and send out a responding frame.

Then, the address searching part 24 writes the transmission source address SA of the received loop back frame to the address table 26 so as to cause the transmission source address SA to correspond to the reception port, and thus updates the address table 26, and the responding frame generating and sending out part 38 generates a responding frame shown in FIG. 3C by incorporating the destination address DA and transmission source address SA (address of the repeating apparatus) of the received loop back frame to the transmission source address SA and destination address DA of the responding frame shown in FIG. 3C, respectively, in a step S44. Then, the generated responding frame is returned only to the transmission source of the received loop back frame, in a step S46.

However, when neither the destination of the received loop back frame is the own repeating apparatus nor the destination address DA of the received loop back frame exists in the address table 26, the address searching part 24 writes the transmission source address SA of the received loop back frame to the address table 26 so as to cause the transmission source address SA to correspond to the reception port and thus updates the address table 26, in a step S48. Further, the loop back receiving part 36 stores the loop back frame to be broadcasted in the loop check buffer 32, and the repeating control part 22 initializes a partial timer of the timer 34 and starts the partial timer corresponding to the loop back frame concerned, in order to prevent generation of infinite loop, in the step S48.

Then, in a step 50, the received loop back frame is sent out and broadcasted through all the ports of the transmission/reception interface ports 20 other than the reception port.

When no identical frame exists in the loop check buffer 32 (No of the step S26) and the received frame is a responding frame (Yes of the step S34), a step S60 of FIG. 6 is proceeded to.

Then, by control of the repeating control part 22, the received frame is provided to a responding receiving part 40.

The responding receiving part 40 determines whether or not the destination of the received responding frame is the address particular to the own repeating apparatus in a step S62.

When the destination address DA of the received responding frame is different from the address particular to the own repeating apparatus, the address searching part 24 writes the transmission source address SA of the received responding frame to the address table 26 so as to cause the transmission source address SA to correspond to the reception port and thus updates the address table 26, in a step S63.

Then, the responding receiving part 40 uses the address searching part 24, searches the address table 26 for a port of the transmission/reception interface ports 20 corresponding to the destination of the received responding frame, and transfers the received responding frame through the thus-detected port, in a step S64.

When the destination of the received responding frame is the own repeating apparatus, the responding receiving part 40 determines in a step S66 whether the partial timer of the timer 34 concerned has finished measuring a predetermined time.

When the partial timer has finished measuring the predetermined time, the responding receiving part 40 discards the received responding frame in order to indicate that the Ethernet data frame stored in the data buffer 30 is already discarded, in a step S68.

When the partial timer of the timer 34 concerned has not finished measuring the predetermined time, the responding receiving part 40 uses the address searching part 24, and writes the transmission source address SA of the received responding frame to the address table 26 so as to cause the transmission address SA to correspond to the reception port, and thus updates the address table 26, and discards the received responding frame concerned, in a step S70.

Then, in a step S72, the responding receiving part 40 reads the Ethernet data frame stored in the data buffer 30 and sends out it based on the thus-updated address table 26. At this time, in order to prevent erroneous operation, the partial timer of the timer 34 corresponding to the thussent-out Ethernet data frame is invalidated.

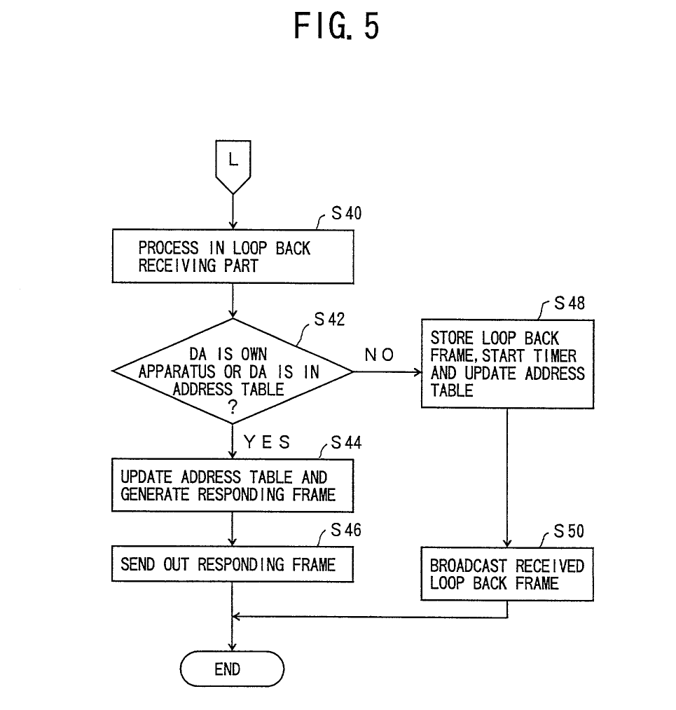

The timer 34 is checked by an interrupt routine shown in FIG. 7 which is started at predetermined time intervals.

In a step S80, each partial timer of the timer 34 is checked. In a step S82, it is determined whether the partial timer has finished measuring the predetermined time. For a partial timer which has finished measuring the predetermined time, the Ethernet data frame stored in the data buffer 30 or the frame stored in the loop check buffer 32 corresponding to the partial timer is discarded in a step S84.

When the received frame is a broadcast Ethernet data frame other than a loop back frame, a step S74 is proceeded to from the step S30.

Then, the repeating control part 22 stores in the loop check buffer 32 the received frame for which it is determined that no identical frame exists in the loop check buffer 32 for preventing an infinite loop from being generated, initializes the partial timer of the timer 34 corresponding to the received frame and starts it.

Further, the repeating control part 22 uses the address searching part 24 and writes the transmission source address SA of the received frame to the address table 26 so as to cause the transmission source adders SA to correspond to the reception port, and thus updates the address table 26.

Then. in a step S76, the received frame concerned is sent out and broadcasted through all the ports of the transmission/reception interface ports 20 other than the reception port.

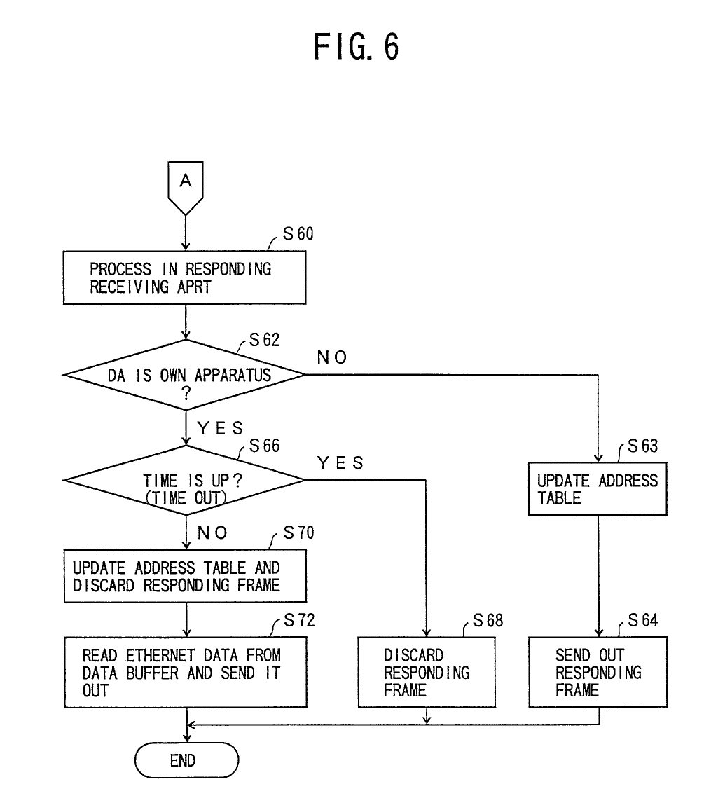

FIG. 8 shows a block diagram of a network in a first embodiment to which the above-described method according to the present invention is applied.

In FIG. 8, a terminal PC1 is connected to a layer 2 LAN repeating apparatus (L2Sw) 51, a layer 2 LAN repeating apparatus 52 and so forth are connected to the layer 2 LAN repeating apparatus 51, a layer 2 LAN repeating apparatus 53 and so forth are connected to the layer 2 LAN repeating apparatus 52, and a terminal PC2 is connected to the layer 2 LAN repeating apparatus 53.

It is assumed that only in the address table 26 of the layer 2 LAN repeating apparatus 53, address information of the terminal PC2 is stored.

In a case where data transmission is performed from the terminal PC1 to the terminal PC2, when the layer 2 LAN repeating apparatus 51 receives an Ethernet data frame addressed to the terminal PC2 from the terminal PC1, the layer 2 LAN repeating apparatus 51 performs the steps S10 and S14, and, as a result, proceeds to the step S18. Then, through the processes of the steps S20 and S22, the layer 2 LAN repeating apparatus 51 broadcasts a loop back frame to the layer 2 LAN repeating appetites 52 and so forth.

In the layer 2 LAN repeating apparatus 52 having received the loop back frame, because no address information of the terminal PC2 to which the loop back frame is addressed exists in the address table 26 thereof, the processes of the steps S40, S48 and S50 are performed. Thereby, the layer 2 LAN repeating apparatus 52 then broadcasts the loop back frame received from the layer 2 LAN repeating apparatus 51 to the layer 2 LAN repeating apparatus 53 and so forth.

In the layer 2 LAN repeating apparatus 53 having received the loop back frame, because the address information of the terminal PC2 to which the loop back frame is addressed exists in the address table 26 thereof, the processes of the steps S40 through S46 are performed. Thus, the layer 2 LAN repeating apparatus 53 returns a responding frame to the layer 2 LAN repeating apparatus 51.

The layer 2 LAN repeating apparatus 51 having receives the responding frame updates the address table 26, and transmits the Ethernet frame stored in the data buffer 30 to the terminal PC2 via the layer 2 LAN repeating apparatus 52 in accordance with the updated address table 26.

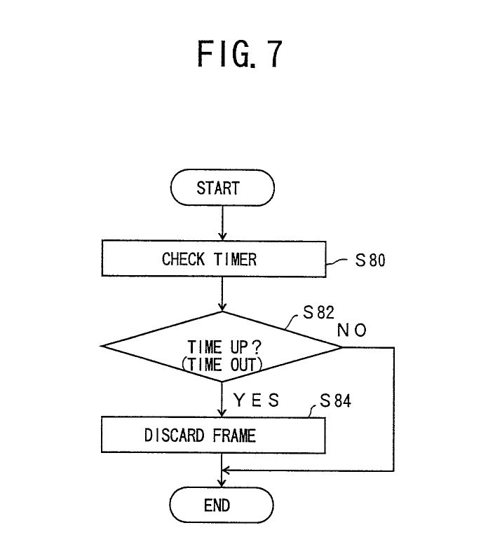

FIG. 9 shows a block diagram of a network in a second embodiment to which the above described method according to the present invention is applied.

In FIG. 9, a terminal PC1 is connected to a port P1 of a layer 2 LAN repeating apparatus (L2Sw) 51, a port P2 of the layer 2 LAN repeating apparatus 51 and a port P1 of a layer 2b LAN repeating apparatus 52 are connected to one another, a port P3 of the layer 2 LAN repeating apparatus 51 and a port P1 of a layer 2b LAN repeating apparatus 53 are connected to one another, and terminals PC2 and PC3 are connected to ports P2 of the layer 2 LAN repeating apparatuses 52 and 53, respectively.

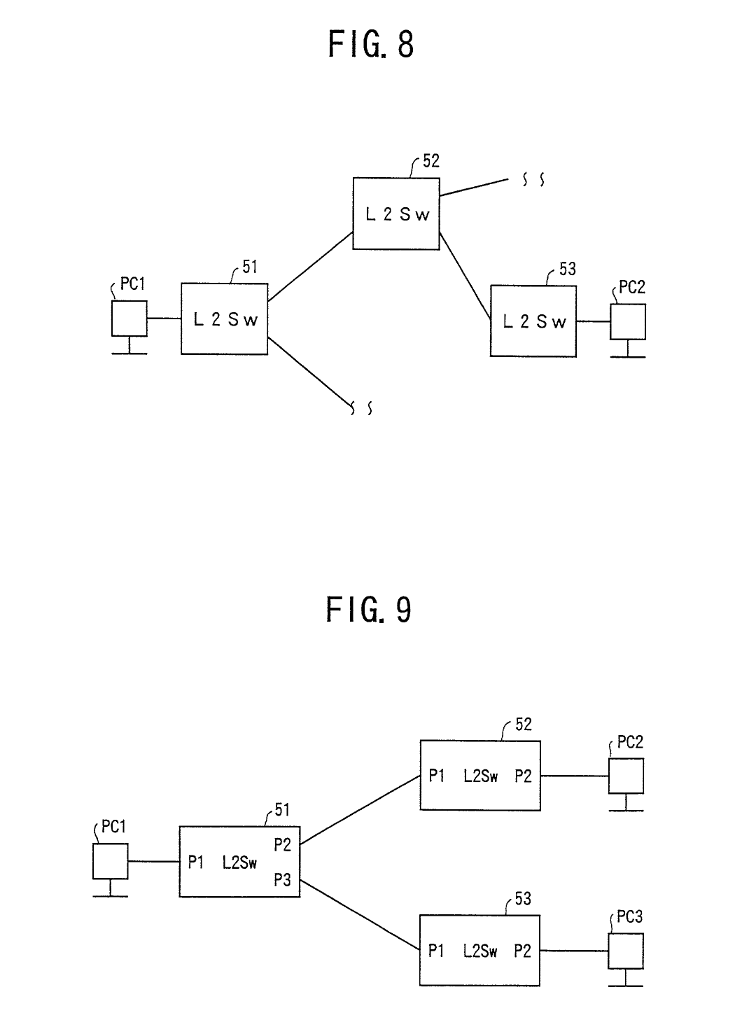

In the address table 26 of the layer 2 LAN repeating apparatus 51 in this state, an address of the terminal PC1 is stored as shown in FIG. 10A. In the address table 26 of the layer 2 LAN repeating apparatus 52, addresses of the terminals PC1 and PC2 are stored as shown in FIG. 10B. In the address table 26 of the layer 2 LAN repeating apparatus 53, the address of the terminal PC1 is stored as shown in FIG. 10C.

In a case where data is transmitted from the terminal PC1 to the terminal PC2, when the layer 2 LAN repeating apparatus 51 receives an Ethernet data frame addressed to the terminal PC2 from the terminal PC1, as a result of performing the steps S10 and S14, proceeding to the step S18, then, in the processes of the steps S20 and S22, the layer 2 LAN repeating apparatus 51 broadcasts a loop back frame to the layer 2 LAN repeating apparatuses 52 and 53.

The layer 2 LAN repeating apparatus 52 having received the loop back frame, because the address of the terminal PC2 which is the destination of the loop back frame exists in the address table 26 thereof, performs the processes of the steps S40 through S46, and returns a responding frame to the layer 2 LAN repeating apparatus 51.

The layer 2 LAN repeating apparatus 51 having received the responding frame updates the address table 26, and transmits the Ethernet data frame stored in the data buffer 30 to the terminal PC2 via the layer 2 LAN repeating apparatus 52 in accordance with the updated address table 26.

Because the layer 2 LAN repeating apparatus 53 does not have the address of the terminal PC2 which is the destination of the received loop back frame in the address table 26 thereof, the layer 2 LAN repeating apparatus 53 performs the processes of the steps S40, S48 and S50, and broadcasts the loop back frame received from the layer 2 LAN repeating apparatus 51.

In this case, only the terminal PC3 receives the broadcasted loop back frame from the layer 2 LAN repeating apparatus 53. Because the received loop back frame is not addressed to the own apparatus, the terminal PC3 discards the loop back frame.

In a case where data is transmitted from the terminal PC1 to the terminal PC3, when receiving an Ethernet data frame addressed to the terminal PC3 from the terminal PC1, as a result of performing the steps S10 and S14, proceeding to the step S18, the layer 2 LAN repeating apparatus 51 broadcasts a loop back frame to the layer 2 LAN repeating apparatuses 52 and 53 in the processes of the steps S20 and S22.

The layer 2 LAN repeating apparatus 52 having received the loop back frame, because the layer 2 LAN repeating apparatus 52 does not have the address of the terminal PC3 which is the destination of the loop back frame in the address table 26 thereof, performs the processes of the steps S40, S48 and S50, and broadcasts the loop back frame received from the layer 2 LAN repeating apparatus 51.

In this case, only the terminal PC2 receives the broadcasted loop back frame from the layer 2 LAN repeating apparatus 52. Because the received loop back frame is not addressed to the own apparatus, the terminal PC2 discards the loop back frame.

The layer 2 LAN repeating apparatus 53 having received the loop back frame, because the layer 2 LAN repeating apparatus 53 does not have the address of the terminal PC3 which is the destination of the loop back frame in the address table 26 thereof, performs the processes of the steps S40, S48 and S50, and broadcasts the loop back frame received from the layer 2 LAN repeating apparatus 51.

In this case, only the terminal PC3 receives the broadcasted loop back frame from the layer 2 LAN repeating apparatus 53. The terminal PC3 recognizes that the received loop back frame is addressed to the own apparatus, and, therefore, returns a responding frame.

The layer 2 LAN repeating apparatus 51 having received the returned responding frame updates the address table 26 thereof, and transmits the Ethernet data frame stored in the data buffer 30 to the terminal PC3 via the layer 2 LAN repeating apparatus 53 in accordance with the updated address table 26.

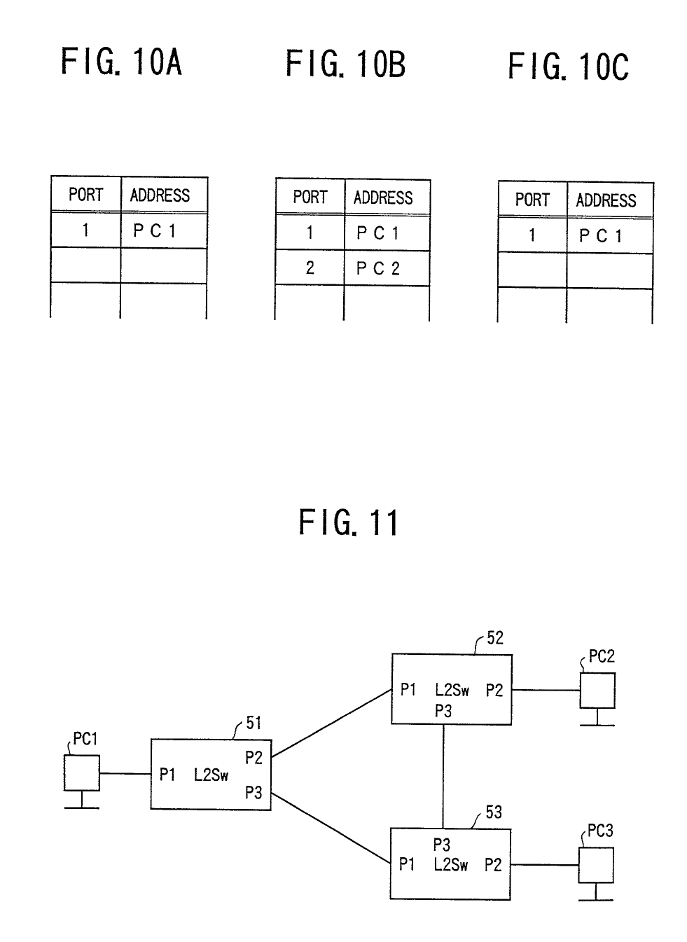

FIG. 11 shows a network in a third embodiment to which the above-described method according to the present invention is applied.

In FIG. 11, a terminal PC1 is connected to a port P1 of a layer 2 LAN repeating apparatus (L2Sw) 51, a port P2 of the layer 2 LAN repeating apparatus 51 and a port P1 of a layer 2 LAN repeating apparatus 52 are connected to one another, and a port P3 of the layer 2 LAN repeating apparatus 51 and a port P1 of a layer 2 LAN repeating apparatus 53 are connected to one another.

Further, terminals PC2 and PC3 are connected to ports P2 of the layer 2 LAN repeating apparatuses 52 and 53, respectively, and ports 3 of the layer 2 LAN repeating apparatuses 52 and 53 are connected to one another.

It is assumed that no address information is stored in the address table 26 of each of the layer 2 LAN repeating apparatuses 51, 52 and 53.

In a case where data is transmitted from the terminal PC1 to the terminal PC2, when the layer 2 LAN repeating apparatus 51 receives an Ethernet data frame addressed to the terminal PC2 from the terminal PC1, as a result of performing the steps S10 and S14, proceeding to the step S18, then, in the processes of the steps S20 and S22, the layer 2 LAN repeating apparatus 51 broadcasts a loop back frame to the layer 2 LAN repeating apparatuses 52 and 53.

The layer 2 LAN repeating apparatus 52 having received the loop back frame, because the address of the terminal PC2 which is the destination of the loop back frame does not exist in the address table 26 thereof, performs the processes of the steps S40, S48 and S50, and broadcasts the loop back frame received from the layer 2 LAN repeating apparatus 51 to the layer 2 LAN repeating apparatus 53 and terminal PC2.

Simultaneously, the layer 2 LAN repeating apparatus 53 having received the loop back frame, because the address of the terminal PC2 which is the destination of the loop back frame does not exist in the address table 26 thereof, performs the processes of the steps S40, S48 and S50, and broadcasts the loop back frame received from the layer 2 LAN repeating apparatus 51 to the layer 2 LAN repeating apparatus 52 and terminal PC3.

Each of the layer 2 LAN repeating apparatus 52 having received the loop back frame from the layer 2 LAN repeating apparatus 53 and the layer 2 LAN repeating apparatus 53 having received the loop back frame from the layer 2 LAN repeating apparatus 52 recognizes that the received loop back frame already exists in loop check buffer 32 thereof. Thereby, each of the layer 2 LAN repeating apparatuses 52 and 53 determines that the loop back frame received from one another is received because of network loop, and discards this loop back frame without further broadcasting it.

The terminal PC2 having received the loop back frame recognizes that the loop back frame is addressed to the own apparatus, and returns a responding frame. The layer 2 LAN repeating apparatus 51 having received the responding frame from the terminal PC2 updates the address table 26, and transmits the Ethernet data frame stored in the data buffer 30 to the terminal PC2 in accordance with the updated address table 26.

Also in a case where an Ethernet data frame which the layer 2 LAN repeating apparatus 51 receives from the terminal PC1 is a broadcast frame, an infinite loop is avoided by processes similar to the above-described processes.

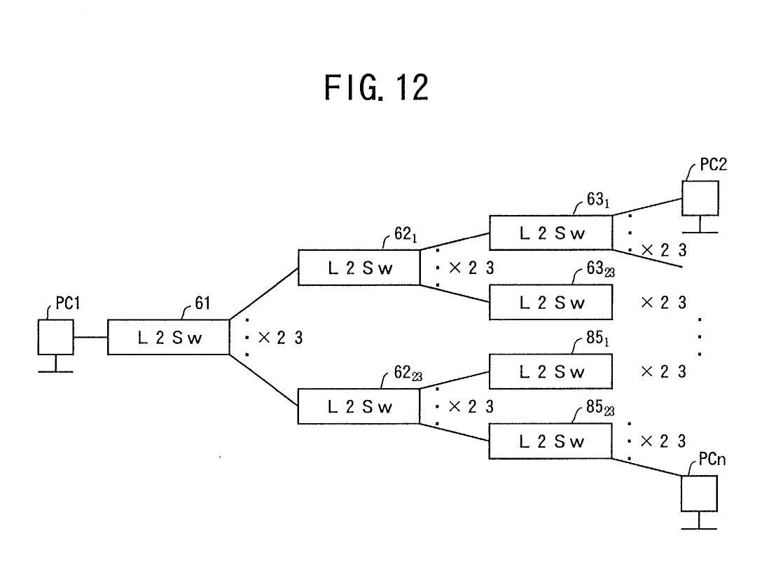

A network is configured as shown in FIG. 12.

In FIG. 12, 24-switchboards each having 24 terminals are used as layer 2 LAN repeating apparatuses, respectively. 23 layer 2 LAN repeating apparatuses 62₁ through 62₂₃ in a second stage are connected to a layer 2 LAN repeating apparatus 61 in a first stage. 23 layer 2 LAN repeating apparatuses 63₁ through 63₂₃, . . . , 85₁ through 85₂₃ in a third stage are connected to each of the layer 2 LAN repeating apparatus 62₁ through 62₂₃ in the second stage. 23 terminals PC2 through PCn are connected to each of the layer 2 LAN repeating apparatus in the third stage.

A worst case is assumed in which an Ethernet data frame addressed to any one of the terminals PC2 through PCn connected to the layer 2 LAN repeating apparatuses in the third stage is transmitted from the PC1 connected to the layer 2 LAN repeating apparatus 61 in the first stage, and none of all the layer 2 LAN repeating apparatuses cannot recognize the destination address of the Ethernet data frame.

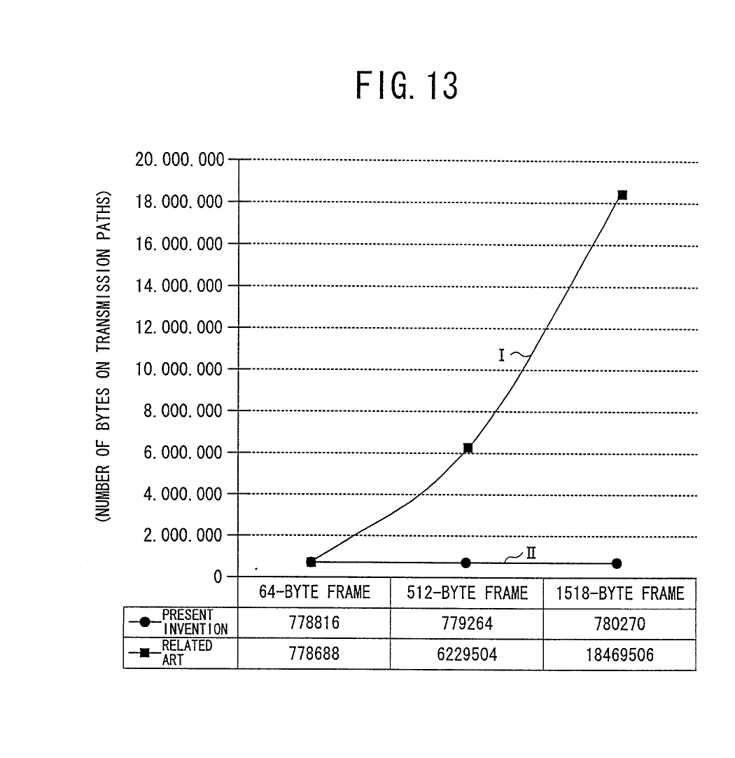

In this case, when the data length of the Ethernet data frame varies from 64 bytes, to 512 bytes and then to 1518 bytes, the traffic amount (the number of bytes) on transmission paths in broadcasting increases exponentially as indicated by the solid line I of FIG. 13 by the method in the related art. However, according to the method of the present invention, it hardly increases as indicated by the solid line II of FIG. 13, and can be controlled to an approximately fixed value.

Thus, in a case where a received frame is a destination-unknown frame, a frame for path detection having a shortest data length (loop back frame, for example) is generated and broadcasted.

Then, when a responding frame is received, the above-mentioned previously received frame is transmitted for the transmission source of the responding frame.

Accordingly, it is possible to reduce a load of a transmission path and to perform efficient communication as a result of a frame broadcasted having a short data length.

Further, a received broadcast frame or a derivative frame (loop back frame, for example) of a destination-unknown frame is stored, and, when the frame same as the previously received frame or derivative frame is received within a predetermined time, the received same frame is discarded.

Accordingly, it is possible to avoid an infinite loop. Further, because STP is not used, there is no possibility that stop of communication occurs at a time of increase of load of transmission path or change of topology.

Further, when a destination-unknown frame for path detection is received, this frame for path detection is held and also is broadcasted. Accordingly, it is possible to search all the paths using the frame for path detection. Further, the time for which a received frame is stored is measured, and, when a predetermined time has elapsed, the received frame is discarded. Accordingly, it is possible to prevent a received frame from being stored for a long time, and thereby to reduce a load.

The present invention is not limited to the above-described embodiments, and variations and modifications may be made without departing from the scope of the present invention.

The present application is based on Japanese priority application No. 2000-009374, filed on Jan. 18, 2000, the entire contents of which are hereby incorporated by reference.

What is claimed is:

1. A communication path control method of a repeating apparatus of a layer 2 LAN, comprising the steps of:
a) when a received frame is a destination-unknown frame, generating and broadcasting a frame for path detection having a shortest data length using a destination address of said received frame and an address of the own apparatus; and
b) when receiving a responding frame returned from a repeating apparatus having found the destination for said frame for path detection, transmitting said received frame for a transmission source of said responding frame.

2. A communication path control method of a repeating apparatus of a layer 2 LAN, comprising the steps of:
a) when a received frame is a broadcast frame or a destination-unknown frame, storing said received frame or a derivative frame thereof; and
b) when receiving the frame the same as said received frame or derivative frame within a predetermined time from the storage of said received frame or derivative frame, discarding the received same frame.

3. A communication path control method of a repeating apparatus of a layer 2 LAN, comprising the steps of:
a) when a received frame is a broadcast frame or a destination-unknown frame, storing said received frame or a derivative frame thereof; and
b) when said received frame is a destination-unknown frame, generating and broadcasting a frame for path detection having a shortest data length using a destination address of said received frame and an address of the own apparatus;
c) when receiving the frame the same as said received frame or derivative frame within a predetermined time from the storage of said received frame or derivative frame, discarding the received same frame;
d) when receiving a responding frame returned from a repeating apparatus having found the destination for said frame for path detection, transmitting said received frame for a transmission source of said responding frame.

4. The method as claimed in claim 1, further comprising the step of, when a received frame is said frame for path detection and is of destination unknown in the own apparatus, holding the received frame for path detection, and also, broadcasting it.

5. The method as claimed in claim 3, further comprising the step of, when a received frame is said frame for path detection and is of destination unknown in the own apparatus, holding the received frame for path detection, and also, broadcasting it.

6. A repeating apparatus of a layer 2 LAN, comprising:
a broadcasting part, when a received frame is a destination-unknown frame, generating and broadcasting a frame for path detection having a shortest data length using a destination address of said received frame and an address of the own apparatus; and
a received-frame transmitting part, when receiving a responding frame returned from a repeating apparatus having found the destination for said frame for path detection, transmitting said received frame for a transmission source of said responding frame.

7. A repeating apparatus of a layer 2 LAN, comprising:
a storing part, when a received frame is a broadcast frame or a destination-unknown frame, storing said received frame or a derivative frame thereof; and
a discarding part, when receiving the frame the same as said received frame or derivative frame within a predetermined time from the storage of said received frame or derivative frame, discarding the received same frame.

8. A repeating apparatus of a layer 2 LAN, comprising:
a storing part, when a received frame is a broadcast frame or a destination-unknown frame, storing said received frame or a derivative frame thereof; and
a broadcasting part, when said received frame is a destination-unknown frame, generating and broadcasting a frame for path detection having a shortest data length using a destination address of said received frame and an address of the own apparatus;
a discarding part, when receiving the frame the same as said received frame or derivative frame within a predetermined time from the storage of said received frame or derivative frame, discarding the received same frame;
a received-frame transmitting part, when receiving a responding frame returned from a repeating apparatus having found the destination for said frame for path detection, transmitting said received frame for a transmission source of said responding frame.

9. The apparatus as claimed in claim 6, further comprising a path-detection broadcasting part, when a received frame is said frame for path detection and is of destination unknown in the own apparatus, holding the received frame for path detection, and also, broadcasting it.

10. The apparatus as claimed in claim 8, further comprising a path-detection broadcasting part, when a received frame is said frame for path detection and is of destination unknown in the own apparatus, holding the received frame for path detection, and also, broadcasting it.

11. The apparatus as claimed in claim 7, further comprising a timer part measuring a time for which said storing part stores the received frame or derivative frame, for, when said predetermined time has elapsed, said discarding part to discard said received frame or derivative frame.

12. The apparatus as claimed in claim 8, further comprising a timer part measuring the time for which said storing part stores the received frame or derivative frame, for, when said predetermined time has elapsed, said discarding part to discard said received frame or derivative frame.
